(19) United States
(12) Patent Application Publication
(10) Pub. No.: US 2018/0105094 A1
(43) Pub. Date: Apr. 19, 2018

(54) Clamping Apparatus that Securely Create an Anchoring Point Along the Side Rails of The Pickup Bed

(71) Applicants: Daniel Marcus Cain, Battle Ground, WA (US); Tanna Kay Cain, Battle Ground, WA (US)

(72) Inventors: Daniel Marcus Cain, Battle Ground, WA (US); Tanna Kay Cain, Battle Ground, WA (US)

(21) Appl. No.: 15/783,927

(22) Filed: Oct. 13, 2017

Related U.S. Application Data
(60) Provisional application No. 62/407,988, filed on Oct. 13, 2016.

(51) Int. Cl. B60P 7/08

(52) U.S. Cl. CPC B60P 7/0815

(57) ABSTRACT

A clamping apparatus that securely creates an anchoring point along the side rails of the pickup bed to efficiently fasten a securing strap or rope includes a pickup bed rail clamp, a T-head tie down, and a strap receiving bracket. An upper jaw and a lower jaw of the pickup bed rail clamp secure the clamping apparatus to the pickup bed through a fastener of the pickup bed rail clamp. The strap receiving bracket is terminally connected to the upper jaw and designed to receive a hook of the securing strap or a knot of the securing rope. The T-head tie down is connected to the upper jaw and the strap receiving bracket. a first V-shaped notch, a second V-shaped notch, and a U-shaped notch of the T-head tie down provide multiple placements for the securing strap or rope to loop around thus secure a load within the pickup bed.

The current application claims a priority to the U.S. Provisional Patent application Ser. No. 62/407,988 filed on Oct. 13, 2016.

### FIELD OF THE INVENTION

The present invention relates generally to a tie-down clamps for a pickup bed. More specifically, the present invention is a clamping apparatus that securely creates an anchoring point along the side rails of the pickup bed to efficiently fasten a securing strap or rope.

### BACKGROUND OF THE INVENTION

A load can be secured to a pickup bed from utilizing stake pocket tie-downs or side rail tie-downs as a securing strap or rope collectively combines all the tie-downs.

The main problem with the stake pocket tie-downs that they are fixed anchor points within the stake pocket of the pickup bed and does not allow the flexibility along the side rails of the pickup bed. In comparison to the stake pocket tie-downs, the side rail tie-downs provide flexibility along the side rails of the pickup bed. However, these side rail tie-downs often requires drilling and modification to the pickup bed in order to properly secure them within the pickup bed. Additionally, the stake pocket tie-downs and the side rail tie-downs often require a user to get into the pickup bed or underneath the side rails of the pickup bed for installation and removal. This can be very difficult and hazardous when a cargo is already loaded to the pickup bed.

It is therefore an objective of the preset invention to provide a clamping apparatus that securely creates an anchoring point along the side rails of the pickup bed to efficiently fasten a securing strap or rope. The present invention can be engaged anywhere on the side rail of the pickup bed between the stake pockets of the pickup bed, allowing the user to efficiently place anchoring points along the pickup bed. The present invention does not require holes to be drilled or modification to the pickup bed during the installation process. Additionally, the present invention can be easily installed or removed from the outside of the pickup bed. Furthermore, the present invention provides plurality of notches that functions as multiple placements for the securing strap or rope to loop around so that the securing strap or rope is able to maximize the tension between the present invention and the cargo.

### BRIEF DESCRIPTION OF THE DRAWINGS

FIG. 1 is a perspective view of the present invention, showing the complete assembly.

FIG. 2 is a side view of the present invention, showing the complete assembly.

FIG. 3 is a front view of the present invention showing the plurality of notches in the T-head tie down.

FIG. 4 is a side view of the upper jaw and the strap receiving bracket of the present invention, without the rubber pad.

FIG. 5 is a side view of the lower jaw of the present invention.

FIG. 6 is a front view of the T-head tie down, showing the plurality of notches and the sections.

### DETAIL DESCRIPTIONS OF THE INVENTION

All illustrations of the drawings are for the purpose of describing selected versions of the present invention and are not intended to limit the scope of the present invention.

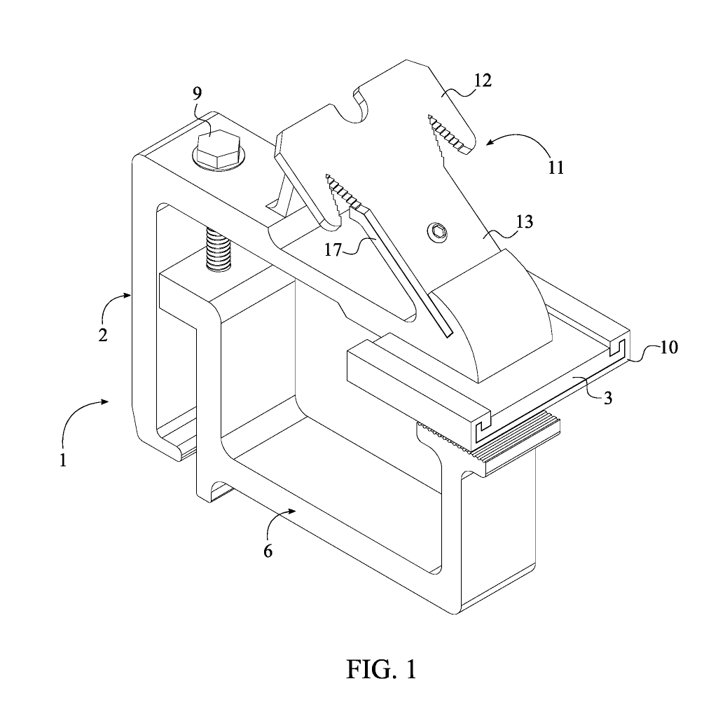

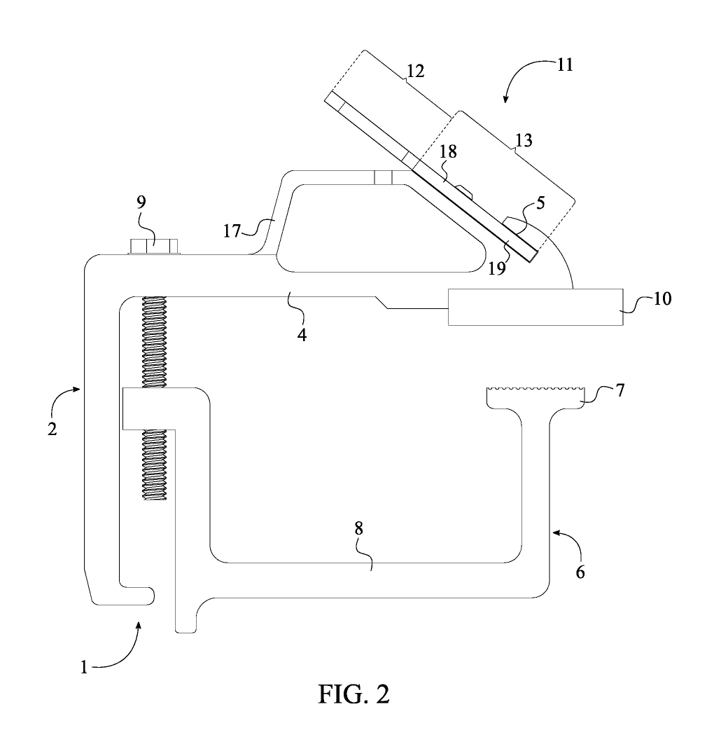

The present invention is a clamping apparatus that securely creates an anchoring point along the side rails of the pickup bed. More specifically, the present invention functions as a side rail tie-down for the pickup bed between stake pockets of the pickup bed thus providing easy installation and removal. The present invention comprises a pickup bed rail clamp 1, a T-head tie down 11, and a strap receiving bracket 17 as shown in FIG. 1-2. The pickup bed rail clamp 1, which secures the present invention to the pickup bed, comprises an upper jaw 2, a lower jaw 6, and a fastener 9 as shown in FIG. 1-2. The T-head tie down 11 that enables the user to loop a securing strap or rope, comprises a crossarm section 12 and a base section 13 as shown in FIG. 1-2. In reference to general configuration of the present invention, a supporting arm 4 of the upper jaw 2 and a supporting arm 8 of the lower jaw 6 are adjustably engaged with each other by the fastener 9 so that the fastener 9 is able to press the upper jaw 2 and the lower jaw 6 against the side rail of the pickup bed. The crossarm section 12 and the base section 13 are adjacently connected to each other thus completing the T-head tie down 11. The strap receiving bracket 17 is terminally connected onto the supporting arm 4 of the upper jaw 2 in order to receive a hook of the securing strap or a knot of the securing rope. The base section 13 is adjacently connected to the strap receiving bracket 17 and the upper jaw 2, providing a secure connection between the pickup bed rail clamp 1 and the T-head tie down 11.

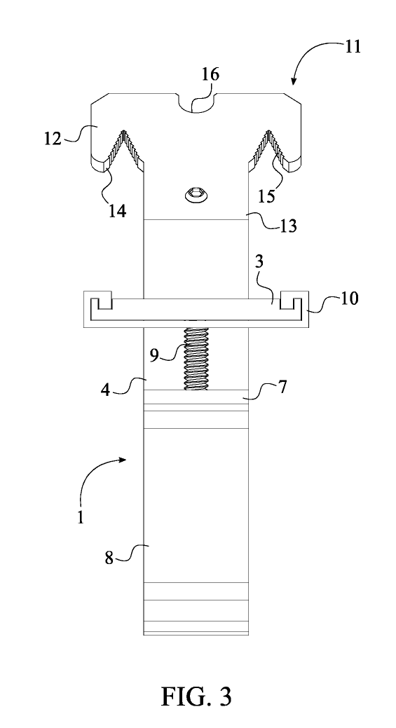

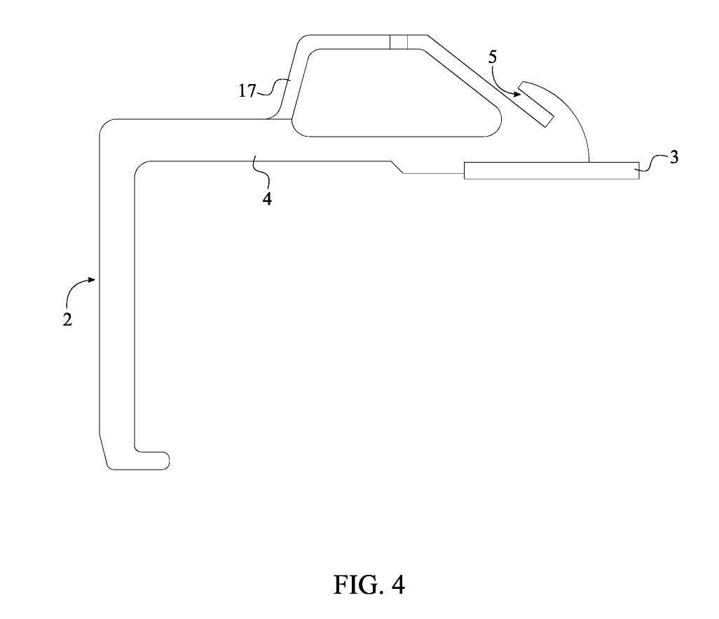

The pickup bed rail clamp 1 enables the user to install or remove the present invention from the outside of the pickup bed. Since the user is not required to get into the pickup bed or underneath the side rails of the pickup bed, a preferred embodiment of the pickup bed rail clamp 1 provide a safe working environment for the user. In reference to FIG. 4, the upper jaw 2 that presses the side rail of the pickup bed from top comprises a bracing platform 3 and a cavity 5. The bracing platform 3 is terminally connected to the supporting arm 4 of the upper jaw 2 as the bracing platform 3 is oppositely positioned to the strap receiving bracket 17. The cavity 5 is angularly traversed into the supporting arm 4 and adjacently positioned to the strap receiving bracket 17. In other words, the strap receiving bracket 17 and the cavity 5 are positioned atop the supporting arm 4 while the bracing platform 3 is positioned below the supporting arm 4. More specifically the supporting arm 4 of the upper jaw 2 functions as the upper structural member so that the bracing platform 3 is able to press against an upper surface of the side rail. The cavity 5 provides an opening within the supporting arm 4 so that the T-head tie down 11 can be securely connected within the present invention. In reference to FIG. 3, a rubber pad 10 is connected to the bracing platform 3 and oriented towards the lower jaw 6. The rubber pad 10 functions as a barrier plate between the bracing platform 3 and the side rail of the pickup bed to protect the finish or the protective coating of the side rail of the pickup bed.

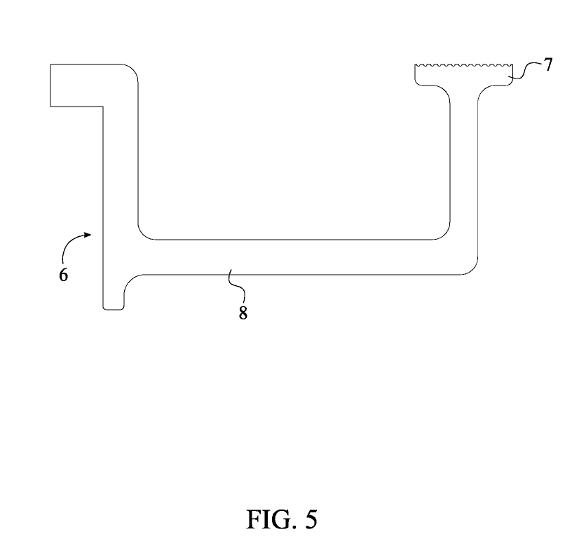

In reference to FIG. 5, the lower jaw 6 that presses the side rail of the pickup bed from below comprises a pressing platform 7. The pressing platform 7 is terminally connected to the supporting arm 8 of the lower jaw 6 as the pressing platform 7 is concentrically positioned to the bracing platform 3 of the upper jaw 2. More specifically the supporting arm 8 of the lower jaw 6 functions as the lower structural member so that the pressing platform 7 is able to move upwardly through the fastener 9 and press against a bottom surface of the side rail.

In reference to FIG. 1-2, the fastener 9 is preferably a threaded bolt. Once the present invention is positioned against the side rail of the pickup bed, a gap between the upper jaw 2 and the lower jaw 6 is manually reduced by tightening the threaded bolt thus converting the rotational motion of the threaded bolt into an upward linear motion of the lower jaw 6. Resultantly, the pressing platform 7 is able to press against the bottom surface of the side rail as the rubber pad 10 and the bracing platform 3 rest against the upper surface of the side rail, creating a friction bond. Even though the present invention utilizes the threaded bolt as the fastener 9, the present invention is not limited to the threaded bolt and can utilize many different fastening mechanisms suitable to engage the upper jaw 2 and lower jaw 6. For example, a torsion spring engaged to a rotational joint may be used to create a clip-like mechanism, magnetic fasteners selectively actuated by circulating a current, a latching system, and many different fastening mechanisms well known and widely utilized in the relevant arts are easily conceivable.

In the preferred embodiment of the pickup bed rail clamp 1, the supporting arm 4 of the upper jaw 2 comprises a L-shaped body and a lower stop, wherein the lower stop is terminally connected to a short leg the L-shaped body and extended towards a long leg of the L-shaped body. The bracing platform 3 is terminally connected to the long leg and oriented parallel with the lower stop. The supporting arm 8 of the lower jaw 6 comprises a U-shaped body and an upper stop as the upper stop is terminally connected to the U-shaped body. Additionally, the upper stop is parallelly positioned in between the lower stop and the long leg. The pressing platform 7 is terminally connected to the U-shaped body and positioned opposite of upper stop. Resultantly, the threaded bolt engages with the long leg and the upper stop in order to reduce the gap between the upper jaw 2 and the lower jaw 6. Likewise, the upper stop acts as a physical barrier against the short leg thus preventing the lower jaw 6 from rotating with respect to the rotational motion of the threaded bolt.

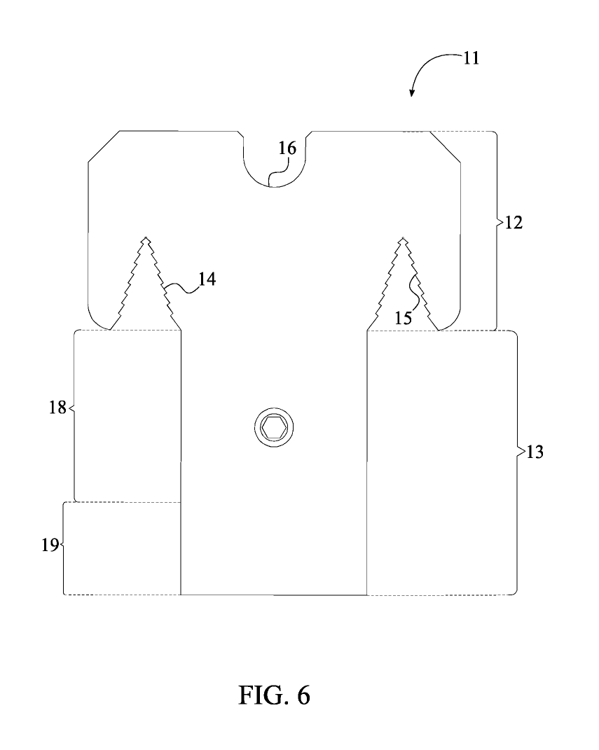

In reference to FIG. 2 and FIG. 6, the base section 13 which connects the T-head tie down 11 to the strap receiving bracket 17 and the upper jaw 2 comprises a first elongated body 18 and a second elongated body 19. More specifically, the first elongated body 18 is adjacently positioned to the crossarm section 12. The second elongated body 19 is adjacently positioned to the first elongated body 18 and positioned opposite of the crossarm section 12. As a result, the first elongated body 18 is adjacently connected to the strap receiving bracket 17 as the second elongated body 19 traverses into the cavity 5 to provide additional support and to prevent angular momentum that may cause by the crossarm section 12.

The T-head tie down 11 enables the user to loop the securing strap or rope. In reference to FIG. 3 and FIG. 6, the T-head tie down 11 further comprises a first V-shaped notch 14, a second V-shaped notch 15, and a U-shaped notch 16. More specifically, the first V-shaped notch 14 and the second V-shaped notch 15 are symmetrically positioned with each other with respect to the base section 13 and traversed into the crossarm section 12, about the base section 13. The U-shaped notch 16 traverses into the crossarm section 12, opposite to the base section 13, and positioned in between the first V-shaped notch 14 and the second V-shaped notch 15. Resultantly, the first V-shaped notch 14, the second V-shaped notch 15, and the U-shaped notch 16 provide multiple placement points for the securing strap or rope to loop around the T-head tie down 11. Additionally, the first V-shaped notch 14 and the second V-shaped notch 15 further comprise a serrated surface to create friction, ensuring secure engagement of the securing strap or rope. In order to maximize tension about the T-head tie down 11, the securing strap or rope is required to helically wrapped around the T-head tie down 11. More specifically, the securing strap or rope is first secured to the strap receiving bracket 17 of the first clamping apparatus and cross over a load of the pickup bed towards the second clamping apparatus. The securing strap or rope is then helically wrapped around the first V-shaped notch 14 of the second clamping apparatus to maximize the tension between the load and the anchoring point. Then, the securing strap or rope can be helically wrapped around the U-shaped notch 16 of the second clamping apparatus, retaining the tension between the load and the anchoring point. The securing strap is then helically wrapped around the second V-shaped notch 15 of the second clamping apparatus so that the securing strap or rope can be engaged with the subsequent clamping apparatus.

Since the present invention is not bolted to the side rails of the pickup bed, the present invention can be placed on the area of the side rails of the pickup bed that would be best used to secure the load. The user can add as many or as few as required to keep the load secure. In order to disengage the anchoring point, the securing strap or rope may be disinserted from the first V-shaped notch 14, the second V-shaped notch 15, and the U-shaped notch 16, allowing the load to be removed from the pickup bed. When the load has been delivered, the present invention can be removed by simply loosening the fastener 9 and disengaging the upper jaw 2 and the lower jaw 6 off the side rail of the pickup bed. Many variations and alterations to the preferred method of engagement between the side rail of the pickup bed and the present invention may be easily conceivable to those with ordinary skills in the relevant arts.

The majority of the present invention may be composed of metallic materials having different densities. The rope may be composed preferably of fabric materials though alternate embodiments may utilize metallic, organic, or synthetic materials well known in the relevant arts. In alternate embodiments of the present invention, it is easily conceivable for each component to be made of a particular material specifically suited to withstand the structural loads and thermal conditions associated with normal and extraneous operating conditions. Additionally, it is easily conceivable to those having ordinary skills in the relevant arts, that fabrics, metals, glass, organic, and/or composite materials may also be utilized.

Although the invention has been explained in relation to its preferred embodiment, it is to be understood that many other possible modifications and variations can be made without departing from the spirit and scope of the invention as hereinafter claimed.

What is claimed is:

1. A clamping apparatus that securely create an anchoring point along the side rails of the pickup bed comprises;
a pickup bed rail clamp;
a T-head tie down;
a strap receiving bracket;
the pickup bed rail clamp comprises an upper jaw, a lower jaw, and a fastener;
the T-head tie down comprises a crossarm section and a base section;
a supporting arm of the upper jaw and the lower jaw being adjustably engaged with each other by the fastener;
the crossarm section and the base section being adjacently connected to each other;
the strap receiving bracket being terminally connected onto the supporting arm of the upper jaw; and
the base section being adjacently connected to the strap receiving bracket and the upper jaw.

2. The clamping apparatus that securely create an anchoring point along the side rails of the pickup bed as claimed in claim 1 comprises;
the upper jaw comprises a bracing platform and a cavity;
the bracing platform being terminally connected to the supporting arm of the upper jaw;
the bracing platform being oppositely positioned to the strap receiving bracket;
the cavity angularly traverses into the supporting arm; and
the cavity being adjacently positioned to the strap receiving bracket.

3. The clamping apparatus that securely create an anchoring point along the side rails of the pickup bed as claimed in claim 2 comprises;
a rubber pad;
the rubber pad being connected to the bracing platform; and
the rubber pad being oriented toward the lower jaw.

4. The clamping apparatus that securely create an anchoring point along the side rails of the pickup bed as claimed in claim 1 comprises;
the lower jaw comprises a pressing platform;
the pressing platform being terminally connected to the supporting arm of the lower jaw; and
the pressing platform being concentrically positioned to a bracing platform of the upper jaw.

5. The clamping apparatus that securely create an anchoring point along the side rails of the pickup bed as claimed in claim 1 comprises;
the T-head tie down further comprises a first V-shaped notch and a second V-shaped notch;
the first V-shaped notch and the second V-shaped notch being symmetrically positioned with each other about the base section; and
the first V-shaped notch and the second V-shaped notch traverse into the crossarm section, adjacent to the base section.

6. The clamping apparatus that securely create an anchoring point along the side rails of the pickup bed as claimed in claim 1 comprises;
the T-head tie down further comprises a U-shaped notch; and
the U-shaped notch traverses into the crossarm section, opposite to the base section.

7. The clamping apparatus that securely create an anchoring point along the side rails of the pickup bed as claimed in claim 1 comprises;
the base section comprises a first elongated body and a second elongated body;
the first elongated body being adjacently positioned to the crossarm section;
the second elongated body being adjacently positioned to the first elongated body, opposite of the crossarm section;
the first elongated body being adjacently connected to the strap receiving bracket; and
the second elongated body traverses into a cavity of the upper jaw.

8. The clamping apparatus that securely create an anchoring point along the side rails of the pickup bed as claimed in claim 1, wherein the fastener being a threaded bolt.
